(19) United States
(12) Patent Application Publication
(10) Pub. No.: US 2020/0127763 A1
(43) Pub. Date: Apr. 23, 2020

(54) USER EQUIPMENT, BASE STATION AND SIGNAL RECEPTION METHOD

(71) Applicant: NTT DOCOMO, INC., Tokyo (JP)

(72) Inventors: Shinpei Yasukawa, Tokyo (JP); Satoshi Nagata, Tokyo (JP); Kazuki Takeda, Tokyo (JP); Qun Zhao, Beijing (CN)

(73) Assignee: NTT DOCOMO, INC., Tokyo (JP)

(21) Appl. No.: 16/473,529

(22) PCT Filed: Dec. 25, 2017
(86) PCT No.: PCT/JP2017/046401

§ 371 Date: Jun. 25, 2019

(30) Foreign Application Priority Data
Dec. 28, 2016 (JP) 2016-257020

(51) Int. Cl. H04L 1/00; H04L 5/00; H04W 76/11; H04L 5/10

(52) U.S. Cl. CPC H04L 1/0068; H04L 5/0082; H04L 5/0051; H04L 5/10; H04W 76/11

(57) ABSTRACT

A user equipment in a radio communication system including a base station and the user equipment, including: a configuration information management unit configured to hold configuration information indicating a protection resource that is a resource that is protected from puncturing that may occur in an assigned resource that is a resource assigned by the base station; and a reception unit configured to receive, from the base station, control information indicating that puncturing occurs in the assigned resource, and receive, from the base station, a predetermined signal using the protection resource based on the configuration information.

### TECHNICAL FIELD

The present invention relates to a user equipment and a base station in a radio communication system.

### BACKGROUND ART

Currently, in the 3rd Generation Partnership Project (3GPP), a next-generation system called 5G, which succeeds the LTE (Long Term Evolution)-Advanced which is one of the fourth generation radio communication systems, is being studied. In 5G, three use cases are assumed, mainly eMBB (extended Mobile Broadband), mMTC (massive machine type communication), and URLLC (Ultra Reliability and Low Latency Communication).

URLLC aims to realize radio communication with low delay and high reliability. As a concrete measure for realizing low delay in URLLC, introduction of Short TTI (Transmission Time Interval) length (also called subframe length, subframe interval, transmission time interval, or slot length), shortening of control delay from packet generation to data transmission and the like are being studied. Furthermore, as a concrete measure for realizing high reliability in URLLC, introduction of encoding method and modulation method of low coding rate to realize low bit error rate, utilization of diversity, and the like are being studied.

In URLLC, it is being studied to realize a U-plane delay of 1 ms, for example, and a packet error rate of, for example, 10\hat{ }-5. In order to realize a low delay, it is being studied to make the TTI length shorter than that of a normal packet (for example, a packet of eMBB traffic). Also, in 5G, it is can be considered that eMBB traffic and URLLC traffic coexist in the same carrier. In that case, since the TTI length of URLLC is shorter than that of eMBB, URLLC data can be transmitted more frequently than eMBB.

### PRIOR ART DOCUMENT

### Non-Patent Document

[Non-Patent Document 1] 3GPP TS 36.321 V13.2.0 (2016-06)
[Non-Patent Document 2] 3GPP TS 36.213 V13.2.0 (2016-06)

### SUMMARY OF INVENTION

### Problem to be Solved by the Invention

As mentioned above, URLLC is aimed at low delay and high reliability, so it is considered that it is necessary to immediately transmit even suddenly occurred traffic. Therefore, when eMBB traffic with a long TTI length and URLLC traffic with a short TTI length coexist in the same carrier, it can be assumed that a case occurs in which resources already allocated to eMBB traffic are punctured (may be referred to as preempt) and URLLC traffic is assigned to the resources. FIG. 2 shows an image in which resources for eMBB traffic are punctured by the arrival of a URLLC packet, as indicated by A.

The above-mentioned puncture may occur on DMRS (DeModulation Reference Signal, demodulation reference signal) for eMBB traffic, for example. When the DMRS is punctured, demodulation and decoding in eMBB traffic cannot be appropriately performed. Such a problem is a problem that can occur not only when the DMRS is punctured but also when other signals such as other reference signals and synchronization signals are punched.

The present invention has been made in view of the above-described problems, and it is an object of the present invention to provide a technique for enabling a user equipment to properly receive a predetermined signal transmitted from the base station even when a part of resources for receiving a signal transmitted from the base station is punctured.

### Means for Solving the Problem

According to a disclosed technique, there is provided a user equipment in a radio communication system including a base station and the user equipment, including:

a configuration information management unit configured to hold configuration information indicating a protection resource that is a resource that is protected from puncturing that may occur in an assigned resource that is a resource assigned by the base station; and

a reception unit configured to receive, from the base station, control information indicating that puncturing occurs in the assigned resource, and receive, from the base station, a predetermined signal using the protection resource based on the configuration information.

### Advantage of the Invention

According to a disclosed technique, there is provided a technique for enabling a user equipment to properly receive a predetermined signal transmitted from the base station even when a part of resources for receiving a signal transmitted from the base station is punctured.

### BRIEF DESCRIPTION OF DRAWINGS

FIG. 1 is a diagram for explaining an example of multiplexing eMBB and URLLC;

FIG. 2 is a diagram for explaining an example of multiplexing eMBB and URLLC;

FIG. 3 is a block diagram in an embodiment of the present invention;

FIG. 4 is a diagram showing an example of DMRS in 1TTI of DL;

FIG. 5 is a diagram showing an example of DMRS in 1TTI of DL;

FIG. 6A is a diagram showing an example of puncture;

FIG. 6B is a diagram showing an example of puncture;

FIG. 7 is a diagram showing an operation example in an example 1;

FIG. 8 is a diagram showing an operation example in the example 1;

FIG. 9 is a diagram showing an operation example in the example 1;

FIG. 10 is a diagram for explaining an operation example of a UE for monitoring normal TTI in the example 1;

FIG. 11 is a diagram for explaining an operation example of a UE for monitoring short TTI in the example 1;

FIG. 12 is a diagram for explaining an operation example of a UE for monitoring normal TTI in the example 1;

FIG. 13 is a diagram for explaining an operation example of a UE for monitoring short TTI in the example 1;

FIG. 14 is a diagram showing an operation example in an example 2;

FIG. 15A is a diagram showing an operation example in an example 3;

FIG. 15B is a diagram showing an operation example in an example 3;

FIG. 16 is a diagram showing an operation example in an example 3;

FIG. 17 is a diagram showing an operation example in an example 3;

FIG. 18 is a diagram showing an operation example in an example 3;

FIG. 19 is a diagram showing an operation example in an example 4 FIG. 20 is a diagram showing an operation example in an example 4;

FIG. 21 is a diagram showing an operation example in an example 5;

FIG. 22 is a diagram for explaining a method for determining a scaling factor in an example 5;

FIG. 23 is a diagram for explaining a method for determining a scaling factor in an example 5;

FIG. 24 is a diagram showing a functional configuration of a user equipment 10;

FIG. 25 is a diagram showing a functional configuration of a base station 20;

FIG. 26 is a diagram showing an example of a hardware configuration of the user equipment 10 and the base station 20.

### EMBODIMENTS OF THE INVENTION

Hereinafter, an embodiment of the present invention (present embodiment) will be described. The embodiment described below is merely an example, and embodiments to which the present invention is applied are not limited to the following embodiments.

When the radio communication system of the present embodiment operates, it is possible to appropriately use the existing technology prescribed in LTE. However, the existing technology is not limited to LTE. In addition, “LTE” used in this specification shall have a broad meaning including LTE-Advanced and schemes (eg, 5 G) after LTE-Advanced unless otherwise specified. Also, the present invention can be applied to communication systems other than LTE.

In the embodiments described below, eMBB communication and URLLC communication are taken as plural types of communication with different TTI lengths, but these are just examples. The present invention is also applicable to communication other than eMBB communication and URLLC communication. Further, the number of types of coexisting communications is not limited to 2. The number of coexisting communication types may be three or more. Hereinafter, for convenience, a long TTI for eMBB is referred to as normal TTI (normal TTI), and a short TTI for URLLC is referred to as short TTI (short TTI). The Short TTI may be realized by shortening the symbol length (increasing the subcarrier interval), or may be realized by reducing the number of symbols used for transmission in one TTI.

In the embodiments described below, terms such as DMRS, TTI, subframe, TB, subcarrier, symbol, resource element, transport block and the like used in the existing LTE are used. However, This is for the sake of convenience of description, signals, functions, etc. similar to these may be referred to by other names.

Further, in the embodiment described below, an example in which the technique according to the present invention is applied to the DL communication from the base station 20 to the user equipment 10 is described. However, The technique according to the present invention is applicable not only to DL communication but also to UL communication and SL (sidelink) communication.

For example, with regard to UL communication, the base station has the function of the user equipment described below and the user equipment has the function of the base station described below, so that application of the technique according to the present invention can be realized. Also, regarding the SL (sidelink) communication, one user equipment has a function of transmitting a signal similar to a signal transmitted by the base station described below, and the other user apparatus has the same function as the user apparatus described below, so that application of the technique according to the present invention can be realized. Apparatuses to which the technique according to the present invention is applied may be collectively referred to as communication apparatuses. However, when applied to SL communication, only notification of control information may be performed by the base station to the user equipment.

Further, in the present embodiment, DMRS is mainly used as an example of a predetermined signal to be protected. However, this is merely an example. The predetermined signal may be a reference signal (RS) other than the DMRS, or a signal or information other than the reference signal, such as control information, broadcast information, system information, or the like.

(Overall System Configuration)

FIG. 3 shows a block diagram of the radio communication system according to the present embodiment. As shown in FIG. 3, the radio communication system according to the present embodiment includes a user equipment 10 and a base station 20.

The user equipment 10 is a communication apparatus having a radio communication function such as a smartphone, a mobile phone, a tablet, a wearable terminal, a communication module for M2M (Machine-to-Machine), and the user equipment 10 connects to the base station 20 by radio, and uses various communication services provided by the radio communication system. The base station 20 is a communication apparatus that provides one or more cells and that performs radio communication with the user equipment 10. In FIG. 3, one user equipment 10 and one base station 20 are shown one by one, but this is an example, and a plurality of user equipments 10 and a plurality of base stations 20 may be provided. The user equipment may be referred to as a UE (User Equipment).

The base station 20 supports both normal TTI and short TTI. It is assumed that the user equipment 10 of the present embodiment supports both normal TTI and short TTI, however, the user equipment 10 may support only one of the normal TTI and the short TTI.

In the present embodiment, HARQ (Hybrid Automatic Repeat request) control such as retransmission is performed when the user equipment 10 receives data in the DL direction. Since the HARQ control described in the present embodiment is basically the same as the HARQ control in the LTE, the outline of the HARQ control in the LTE will be described.

In the user equipment and the base station in LTE, HARQ (Hybrid ARQ) control is performed in an HARQ entity of the MAC (Media Access Control) layer (Non-Patent Document 1). In the HARQ control for downlink data in the user equipment, if decoding (decoding) of the downlink data (TB: transport block) succeeds, ACK is returned to the base station, and if decoding fails, NACK is returned to the base station. In HARQ, the user equipment holds received (detected) data (LLR, for example, more specifically) when decoding (decoding) of the data fails, combines (soft-combines) data retransmitted from the base station with the held data, and decodes the combined data. In this way, strong resistance to error is given. The storage unit (memory area) holding the above data is called a soft buffer.

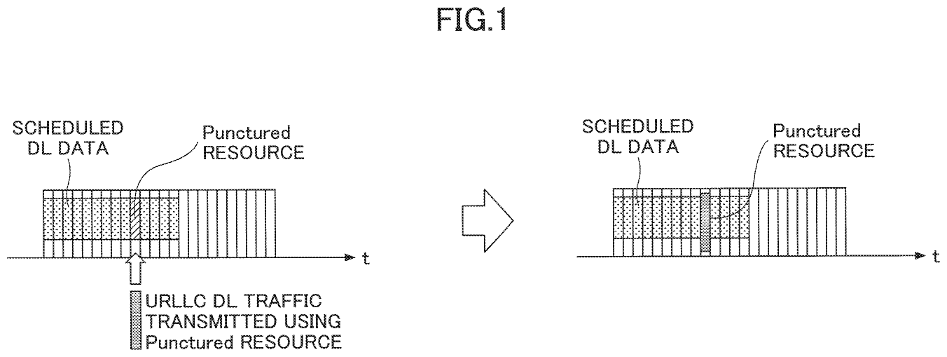

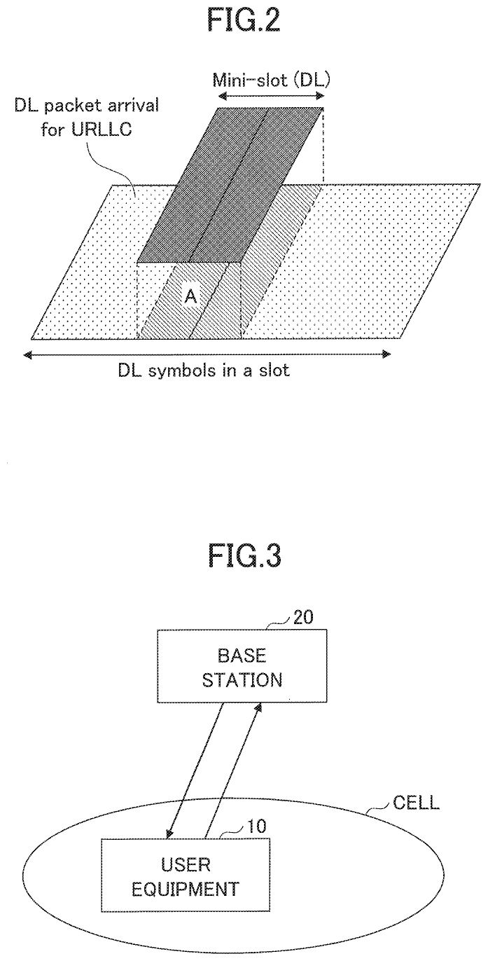

In the present embodiment, as shown in FIG. 1, the user equipment 10 may receive data of eMBB, from the base station 20, by a resource in which a part of the resource is punctured by URLLC. Here, the puncture is, for example, not to transmit the corresponding data in the resource to which the data is mapped, and no transmission may be performed by the resource, or other data may be transmitted with the resource. In the present embodiment, the base station 20 notifies the user equipment 10 of information indicating that there is a punctured resource (eg, a symbol including a punctured resource), so that the user equipment 10 can perform decoding processing or the like considering that punctured resources are included.

(Configuration Example of DMRS)

In the present embodiment, since protection of DMRS from puncture in the normal TTI is mainly explained, an example of DMRS mapping in the normal TTI of the present embodiment will be described first.

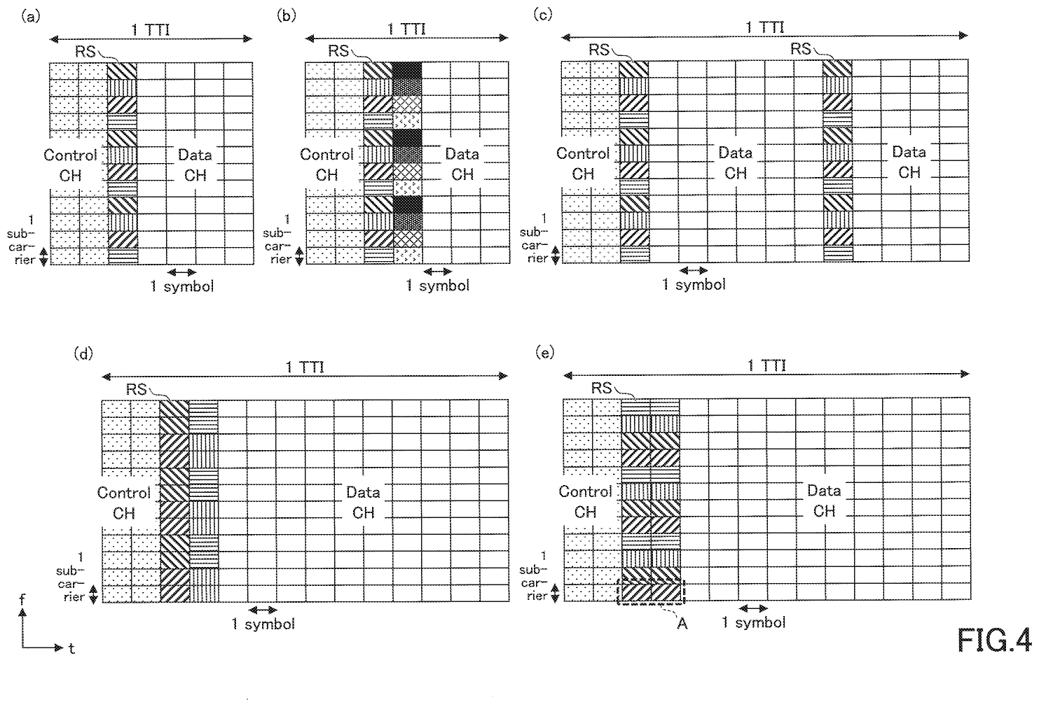

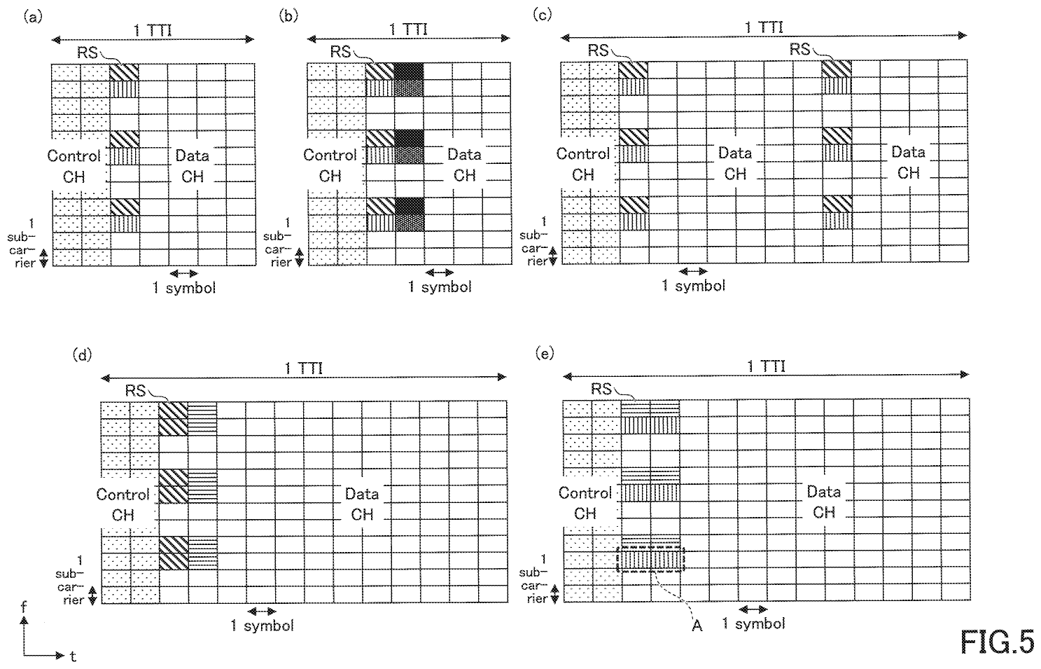

FIG. 4 (a) to 4 (e) show examples of DMRS mapping in normal TTI. For example, as shown in FIG. 4 (a), a control channel is arranged at the head of the TTI and the DMRS is placed at the head of a data channel (data resource). Further, in FIGS. 4 (a) to 4 (e), the difference in shading pattern of DMRS (indicated as RS in the figure) indicates the difference in antenna ports. In the present embodiment targeting DL, the DMRS is a reference signal transmitted together with data from the base station 20, and is not transmitted when there is no data transmission. However, DMRS may be transmitted even when there is no data transmission.

DMRSs for a plurality of antenna ports are multiplexed by TDM, FDM, CDM or the like as shown in FIGS. 4 (a) to 4 (e). A in FIG. 4 (e) indicates that two consecutive REs (resource elements) are multiplexed by CDM for a plurality of antenna ports.

FIGS. 5 (a) to 5 (e) show other examples of mapping. In FIGS. 5 (a) to 5 (e), DMRSes are distributed in the frequency direction. A in FIG. 5 (e) indicates that two consecutive REs (resource elements) are multiplexed by CDM for a plurality of antenna ports.

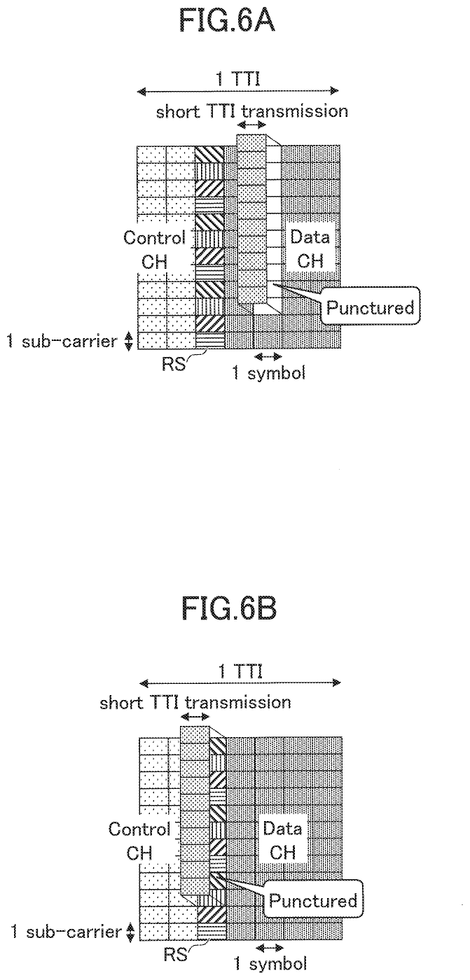

FIGS. 6A and 6B show an example of a case where a part of resources in normal TTI is punctured by DL transmission in short TTI. As shown in FIG. 6B, the DMRS resources in the normal TTI may be punctured by the DL transmission in the short TTI. In the present embodiment, it is possible to protect DMRS even in such a case. Hereinafter, a concrete method for doing so will be described using examples. Any plural number of examples (including all examples) in examples 1 to 5 described below can be implemented in combination.

### Example 1

In the example 1, several RE patterns (referred to as protection patterns) for protecting RE of normal TTI are predetermined. The pattern may be configured in advance in the user equipment 10 and the base station 20 (that is, preconfigured or predefined), or the pattern may be configured by using broadcast information or higher layer signaling from the base station 20 to the user equipment 10. Based on the DL L1/L2 control signal (eg, PDCCH, MAC signal, etc. in the normal TTI and/or short TTI), the base station 20 notifies the user equipment 10 of an index for specifying the pattern, and the RE in the pattern is protected. That is, the base station 20 does not puncture the RE, so that the user equipment 10 can receive a desired signal at the RE even when puncturing occurs.

The user equipment 10 receiving the short TTI performs reception operation of short TTI on the assumption that data is not mapped in the RE corresponding to the protection pattern. For example, the user equipment 10 can perform processing such as not performing demodulation operation on the RE. Alternatively, the user equipment 10 can perform operation of discarding the data demodulated in the RE.

In addition, the user equipment 10 receiving the normal TTI performs normal TTI reception operation assuming that the RE corresponding to the protection pattern is protected and that puncturing is not performed. For example, even when the user equipment 10 is notified that a time/frequency region including the resource of DMRS is punctured, it can be regarded that the DMRS transmitted with the protected RE is not punctured, and the user equipment 10 can perform channel estimation operation using the DMRS in the protected RE.

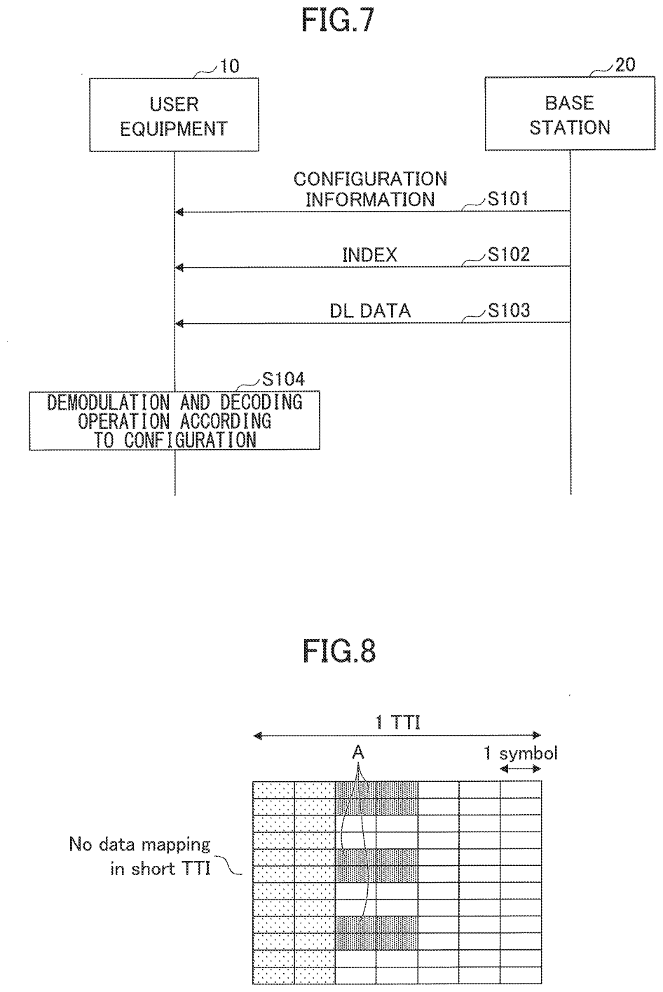

An example of operation in the example 1 will be described with reference to FIG. 7. In step S101, one or more protection patterns are transmitted from the base station 20 to the user equipment 10 as configuration information, and the user equipment 10 holds the protection pattern.

In step S102, an index indicating a specific protection pattern is transmitted from the base station 20 to the user equipment 10 by, for example, a PDCCH for resource allocation of normal TTI, and the user equipment 10 receives the index.

In step S103, the base station 20 transmits the data together with the DMRS to the user equipment 10. The base station 20 allocates resources so as not to puncture the RE of the protection pattern corresponding to the index transmitted in step S102. Since this protection pattern assumes mapping of DMRS of normal TTI, DMRS is protected by this.

In step S104, even when the user equipment 10 is notified that a resource is punctured, for the REs of the pattern corresponding to the index received in step S102, the user equipment 10 determines that there is no puncture and performs reception operation (eg, channel estimation, etc.) of signals (eg, DMRS).

If there is no DL data transmission in the normal TTI, the base station 20 and the user equipment 10 do not perform the protection operation of the RE based on the protection pattern. In this case, the base station 20 can use all the REs for transmission in the short TTI, and the user equipment 10 does not need to consider RE protection (puncture in short TTI) in reception in the short TTI.

By the processing operation as described above, a minimum set of REs is protected. Instead of notifying the protected RE by transmitting the index with the L1/L2 control signal as described above, the protection pattern may be transmitted from the base station 20 to the user equipment 10 by higher layer signaling (eg, RRC signaling). In this case, for example, a protected RE is configured with a protection pattern as indicated by A in FIG. 8. However, even in this case, if there is no DL data transmission in the normal TTI, the base station 20 and the user equipment 10 do not perform the RE protection operation based on the protection pattern. In this case, the base station 20 can use all the REs for transmission in the short TTI, and the user equipment 10 does not need to consider RE protection (puncture in short TTI) in reception in the short TTI.

<Example of Protection Pattern>

For example, the following information can be used as a protection pattern configured in advance (eg, information notified in S101 of FIG. 7).
antenna port index, or set of a plurality of antenna port indexes
DMRS mapping pattern or set of a plurality of DMRS mapping patterns
configuration information for each symbol reflecting mapping of DMRS
Pattern for DMRS protection from short TTI transmission

<Dynamic Indication of Protection Pattern>

As described by way of example in S102 of FIG. 7, a dynamic indication of the protection pattern can be included in scheduling indication. In this case, for example, the protection pattern is dynamically notified to the user equipment 10 that receives the short TTI, so that when there is no DL data transmission in the normal TTI, the user equipment 10 can use all the REs in the short TTI.

The dynamic indication of the protection pattern may be specific to each UE or common to a group of UEs. By making the indication common to a group of UEs, the signaling overhead can be reduced.

<Protection without indication of protection pattern>

For example, any one or more of DMRS for a DL control channel, RS for measurement, and the synchronization signal may be protected without an indication of the protection pattern. As a result, the protection pattern to be notified can be simplified and the signaling overhead can be reduced.

Operation examples 1 to 5 will be described below as an example of operation of the user equipment 10 more specifically with reference to the drawings.

### Operation Example 1

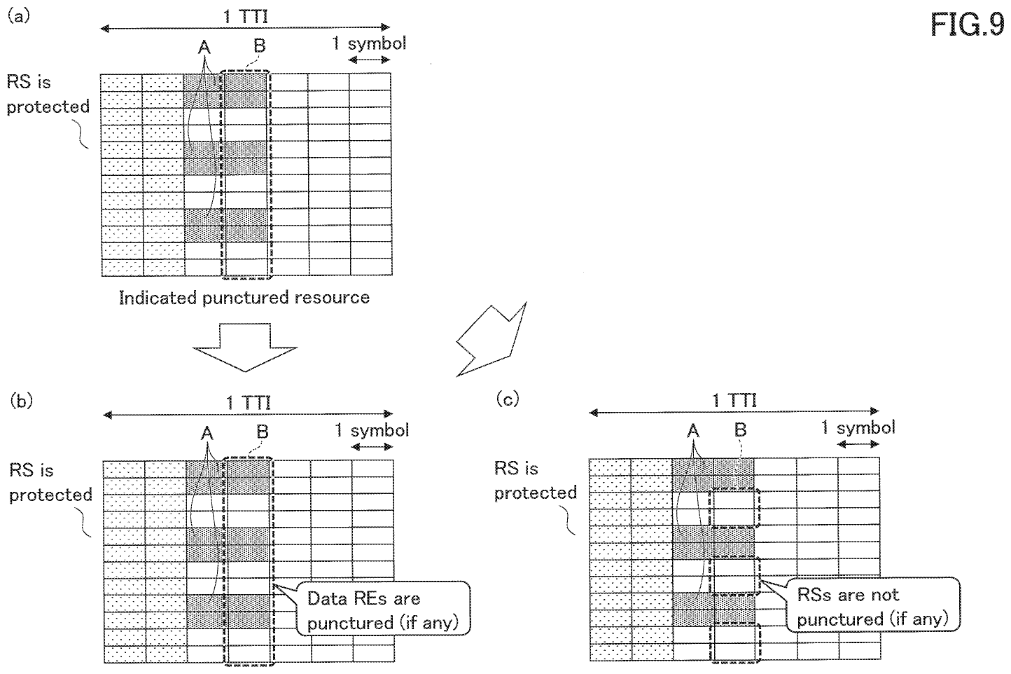

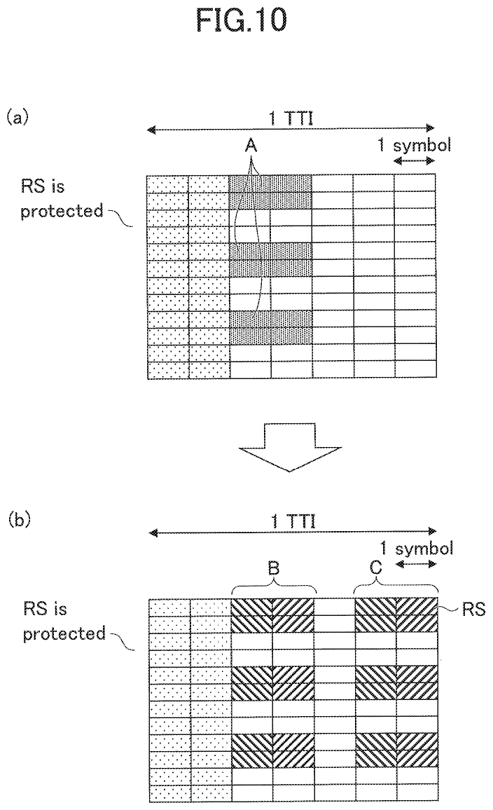

First, the operation example 1 will be described with reference to FIG. 9. In this case, as indicated by A in FIGS. 9 (a) to 9 (c), the protection pattern of RE is configured in the normal TTI. The protection pattern here corresponds to the DMRS pattern in the normal TTI, and the configuration contents of the protection pattern are the same in FIGS. 10-13.

When the user equipment 10 that receives the normal TTI receives information, from the base station 20, indicating that a symbol # n (indicated by B in FIG. 9 (a)) is punctured, as shown in FIG. 9(b), the user equipment 10 determines that an RE on which data in the resource for which the puncture is designated is punctured. Also, as shown in FIG. 9 (c), even for a resource for which puncture is specified, the user equipment 10 determines that DMRS on the protection pattern is protected without being punctured, and performs channel estimation by the DMRS.

### Operation Example 2

Next, as an operation example 2, an operation example of the user equipment 10 that monitors the normal TTI will be described with reference to FIG. 10.

In the state where the protection pattern shown in FIG. 10 (a) is configured, as shown in FIG. 10 (b), when DMRS and data are transmitted from the base station 20, the user equipment 10 determines that DMRS in two symbols indicated by B is protected. On the other hand, since the DMRS in two symbols indicated by C is not on the protection pattern, it can be punctured. Therefore, the user equipment 10 holds a channel estimation result estimated by the DMRS of the symbols indicated by B, so that when receiving a puncture indication after a normal TTI scheduling instruction, the user equipment 10 may determine not to use the symbol resource indicated by C for channel estimation.

### Operation Example 3

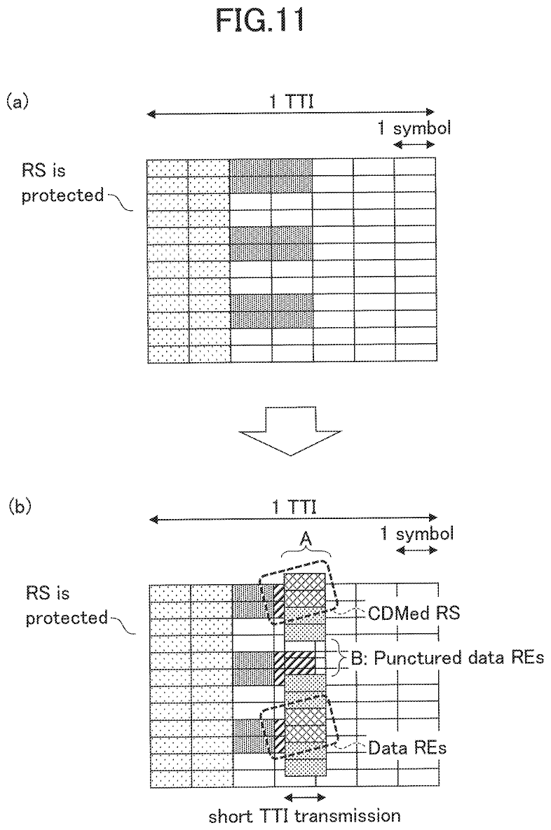

Next, as an operation example 3, an operation example of the user equipment 10 that monitors the short TTI will be described with reference to FIG. 11. For the normal TTI, it is assumed that DMRS and data transmission operation shown in FIG. 10 is performed.

As shown in FIG. 11 (b), DMRS and data in the short TTI are transmitted from the base station 20 with the symbol indicated by A. The DMRS in the short TTI corresponding to protection pattern RE of normal TTI in a symbol indicated by A is multiplexed with the DMRS in the normal TTI by CDM. Also, as shown in B, the signal in the short TTI of RE corresponding to the protection pattern of normal TTI is punctured.

### Operation Example 4

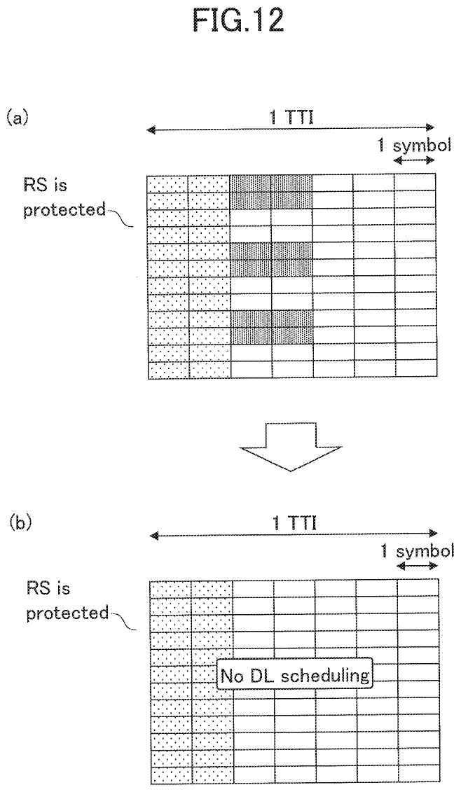

Next, as an operation example 4, an operation example of the user equipment 10 that monitors normal TTI will be described with reference to FIG. 12. In Operation Example 4, the protection pattern is configured as shown in (a), but there is no transmission of DL data in the normal TTI.

### Operation Example 5

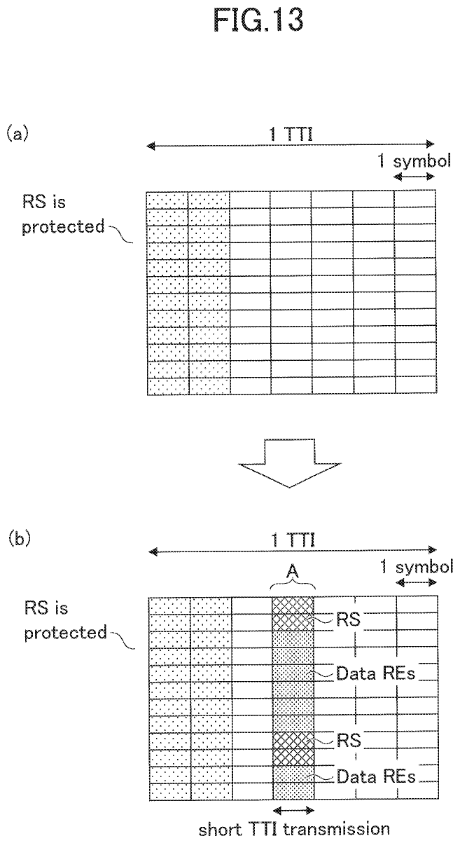

Next, as an operation example 5, an operation example of the user equipment 10 that monitors the short TTI will be described with reference to FIG. 13. For normal TTI, there is no transmission of DL data as shown in FIG. 12.

As shown in FIG. 13 (b), DMRS and data in the short TTI are transmitted using the symbol indicated by A which is a symbol having a protection pattern. The user equipment 10 can receive DMRS and data in the short TTI without being affected by the protection pattern (without being punctured) in the short TTI since there is no DL data transmission in normal TTI as shown in FIG. 12(b).

### Example 2

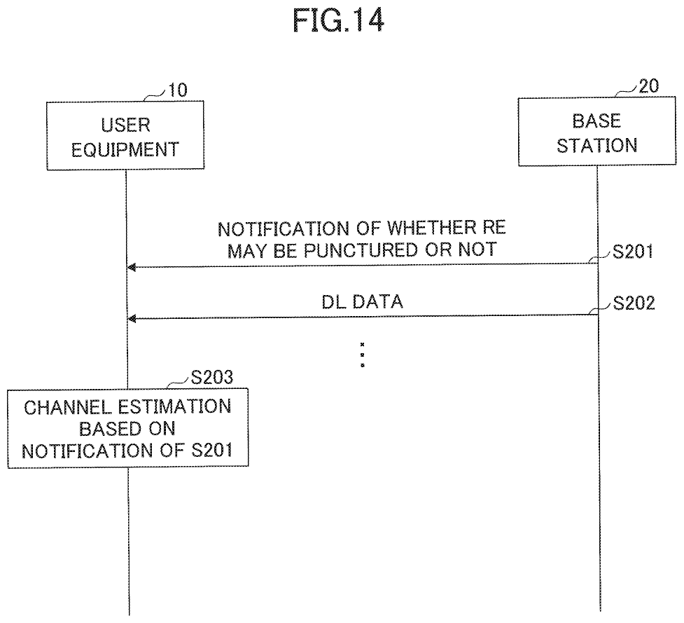

Next, an example 2 will be described with reference to FIG. 14. The example 2 is based on the example 1. In step S201, the base station 20 notifies the user equipment 10 of information indicating whether one or more REs in the normal TTI may be punctured. In step S202, DMRS and data are transmitted in the normal TTI from the base station 20 to the user equipment 10.

If the notification in step S201 is a notification indicating that one or more REs can be punctured, in step S203, the user equipment 10 that receives data in the normal TTI holds the channel estimation result by the DMRS without performing averaging of time and frequency until receiving notification of puncture resources from the base station 20. The retained channel estimation result can be used, for example, as a channel estimation result in the vicinity of punctured DMRS.

The situation here is shown in FIG. 10 (b), for example. Here, it is assumed that the user equipment 10 has received a notification indicating that one or a plurality of REs can be punctured. Then, the user equipment 10 holds the channel estimation result by the DMRS in the symbol indicated by B in FIG. 10 (b). Then, for example, when the user equipment 10 receives a notification indicating that a symbol shown in C is punctured using a symbol between B and C, the user equipment 10 can use the channel estimation result by the symbol indicated by B as a channel estimation result in the symbol indicated by C without performing channel estimation in the symbol indicated by C.

According to the present example, the user equipment 10 can perform buffering of the channel estimation result and the like based on the notification from the base station 20, so that the TTI for buffering can be minimized.

### Example 3

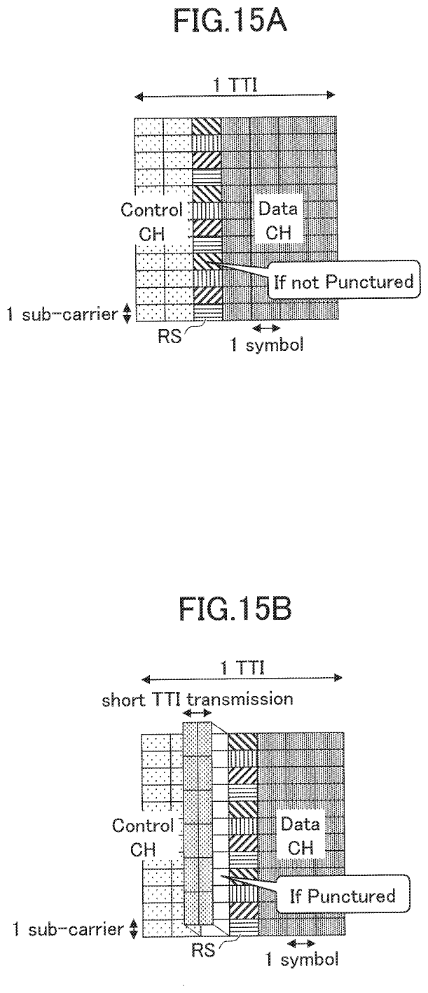

Next, an example 3 will be described. In the third embodiment, the position of the DMRS in the normal TTI punctured by the transmission in the short TTI (the position of the RE to which the DMRS is mapped) may be changed. For example, when a DMRS shown in FIG. 15A is punctured as shown in FIG. 15B, the position of the DMRS is changed as shown in FIG. 15B.

Information on whether the DMRS is protected as described in Examples 1 and 2, whether the position is changed or punctured as described above is implicitly estimated (inferred) in the user equipment 10. Alternatively, the base station 20 may notify the user equipment 10 of the information explicitly.

In the case where the position of DMRS is changed by puncture, the location of the change destination may be inferred implicitly in the user equipment 10. For example, this can be realized by deciding the position of the change destination as the symbol next to the position to be punctured.

In addition, the base station 20 may explicitly notify the user equipment 10 of the position of the change destination. For example, the base station 20 may dynamically notify of puncture resources with the position of the change destination, or may semistatically notify of a pattern of change destination and then, dynamically notify of an index of the pattern.

A more detailed example will be described below.

<Example when Estimation is Performed Implicitly>

The user equipment 10 can determine whether DMRS corresponding to a puncture resource is protected, whether the position of the DMRS is changed, or whether the DMRS is punctured or not, based on the position of RE of a DMRS to be punctured (preempted). For example, when the RE of the first DMRS in a certain normal TTI is punctured (preempted) by short TTI transmission, the transmission of the DMRS is protected or the position of the DMRS is changed.

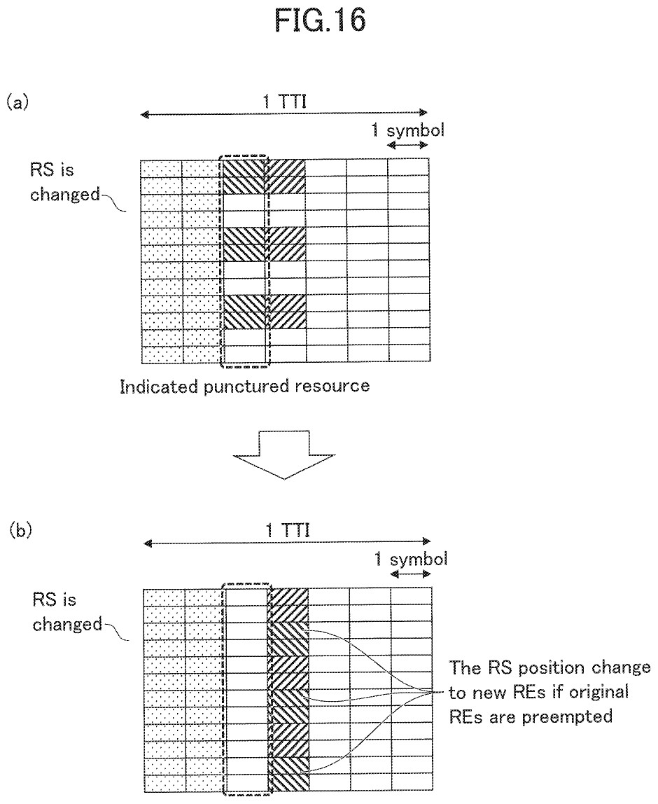

FIGS. 16(a), (b) show an example in a case in which, when the RE of the first DMRS is punctured (preempted) by short TTI transmission, the position of the DMRS is changed to the next symbol.

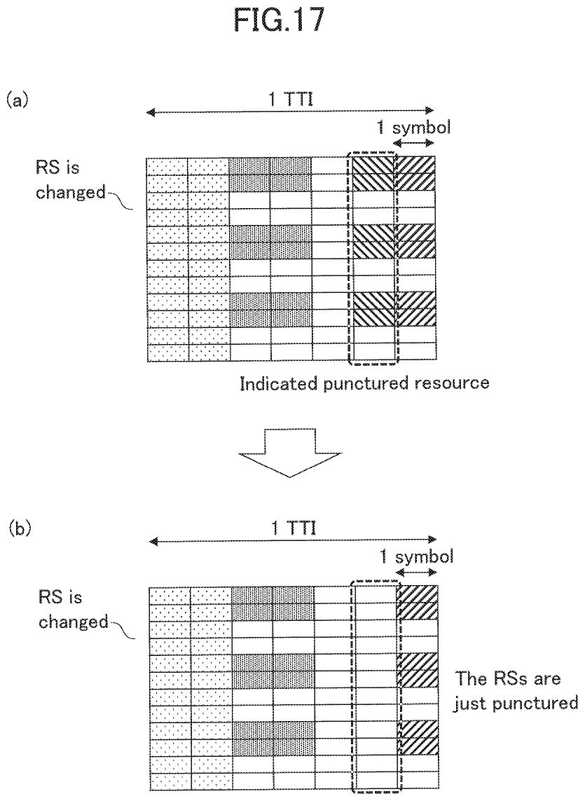

When an RE other than the RE in the first DMRS is punctured (preempt) by short TTI transmission, the DMRS is punctured and the channel estimation result by the previous DMRS is used as the channel estimation result. FIGS. 17 (a) and 17 (b) show examples in this case.

As already described, this example is directed to DMRS, but the same control as DMRS may be applied to RSs other than DMRS. However, DMRS and other RSs may be treated differently. For example, when the RE to be punctured (preempt) is an RE of the DMRS, the user equipment 10 may determine that the DMRS is protected or the position of the DMRS is changed, or when the RE to be punctured (preempted) is an RE of an RS (eg, CSI-RS) other than the RE of the DMRS, the user equipment 10 may determine that the RE is punctured.

<Example when Notifying Explicitly>

Information (indication or configuration) indicating whether the DMRS corresponding to the puncture resource is protected, the position of the DMRS is changed, or whether the DMRS is punctured, may be dynamically notified by DCI (example: scheduling information), or dynamically notified by puncture resource notification (which may be called preemption indication). The puncture resource notification may be included in the DCI.

For example, when the RE of the DMRS is punctured, a pattern indicating the location (RE or the like) of the change destination of the DMRS may be notified. Also, whether the RE in the DMRS pattern is protected or whether its position is changed may be reported with 1 bit.

The notification for explicit notification may be cell specific or may be UE specific. Also, the notification may be performed by upper layer signaling.

<About Changing the Position of DMRS>

In the case where the position of the DMRS is changed by puncture (preemption), the base station 20 may explicitly notify the user equipment 10 how the position is changed. For example, information indicating a change destination position (eg, a frequency position offset indicating a difference from the original position) may be notified by puncture resource notification.

Alternatively, the location of the change destination may be semistatically configured. It is also possible to preset some change destination patterns and dynamically specify the index indicating a specific pattern from the base station 20 to the user equipment 10.

Alternatively, it may be estimated implicitly. For example, the position of the change destination may be determined as a symbol closest to the puncture resource. Also, a fixed timing offset may be used.

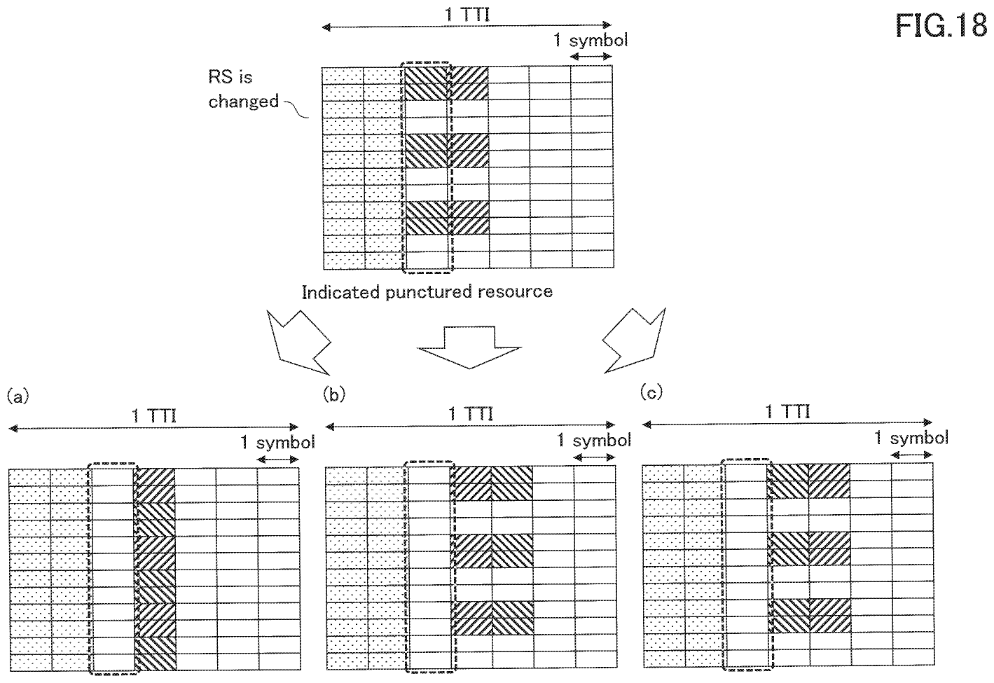

FIG. 18 (a) shows an example where the time position of the change destination is the next symbol of the puncture resource, and the frequency position of the change destination is determined by the frequency domain offset. FIG. 18 (b) shows an example where the location of the change destination is determined as an available RE after the puncture resource.

FIG. 18 (c) shows an example in which the DMRS of a symbol affected by puncture and its subsequent DMRS are changed in position with the same time offset. The RE that is the change destination is an available RE after the puncture resource.

### Example 4

Next, an example 4 will be described. In the example 4, the user equipment 10 supports both eMBB and URLLC. That is, the user equipment 10 can support a plurality of TTI lengths and can simultaneously perform operations for the plurality of TTI lengths. In the following description, it is assumed that the DL control channel for eMBB and the DL control channel for URLLC are separate. However, this is merely an example. For example, control information for URLLC may be transmitted on a DL control channel for eMBB, or control information for eMBB may be transmitted on a DL control channel for URLLC

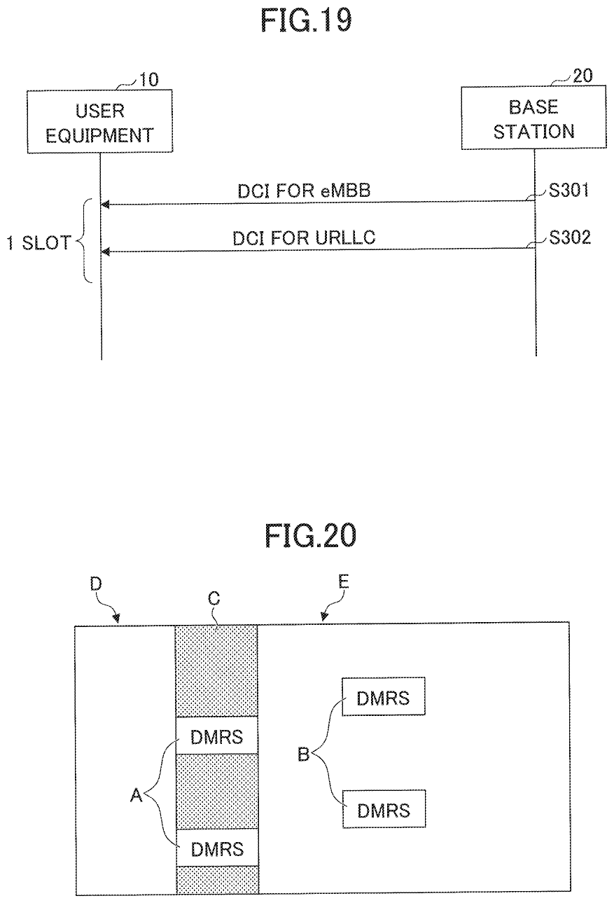

The user equipment 10 can monitor both the DL control channel for eMBB and the DL control channel for URLLC. An example of the operation will be described with reference to FIG. 19.

In step S301, the user equipment 10 receives a DCI for eMBB by a DL control channel for eMBB. In the DCI, for example, in addition to scheduling information data for eMBB, information of puncture resources (eg, a number of a symbol to be punctured) and a protection pattern (an index etc. described in the example 1) are included.

When the user equipment 10 detects that information of a puncture resource is included in the DCI for eMBB, the user equipment 10 further monitors the DL control channel for URLLC to receive a DCI for URLLC in step S302. In the DCI, for example, scheduling information of data for URLLC is included.

Also, in the present example, in the DCI for URLLC, in addition to scheduling information for data for URLLC, or instead of scheduling information for data for URLLC, information indicating that additional DMRS for eMBB is transmitted is included.

That is, after grasping puncture and a protection pattern from the DCI for eMBB, the user equipment 10 receives a DCI for URLLC DCI in the same slot, for example, and the user equipment 10 acquires information of additional DMRS (eg, a symbol and frequency position and the like in which DNRS is transmitted) from the DCI for URLL so as to be able to perform channel estimation using the DMRS.

In other words, for example, the user equipment 10 receives, by a DL control channel of a slot, a DCI for eMBB including information indicating that the symbol 2 is to be punctured and a protection pattern # x. In addition, the user equipment 10 receives a DCI for URLLC including information indicating that (data of) the symbol 10 is punctured and information indicating that the position of the additional DMRS is the symbol 10 by another DL control channel (DL control channel for URLLC here) near the center of the slot for example. The user equipment 10 can perform channel estimation using the DMRS received with the symbol 10.

For example, in the example shown in FIG. 20, the user equipment 10 receives the DCI for eMBB at the time indicated by D, thereby recognizing puncture of a symbol shown in C and protection of a DMRS shown in A, and receives the DCI for URLLC at the time indicated by D, thereby recognizing that a DMRS indicated by B is added.

### Example 5

Next, an example 5 will be described. As described above, when protecting (not use for short TTI) a part of resources punctured for transmission in short TTI for normal TTI, the number of REs available for short TTI is limited in a certain bandwidth (resource blocks to be scheduled).

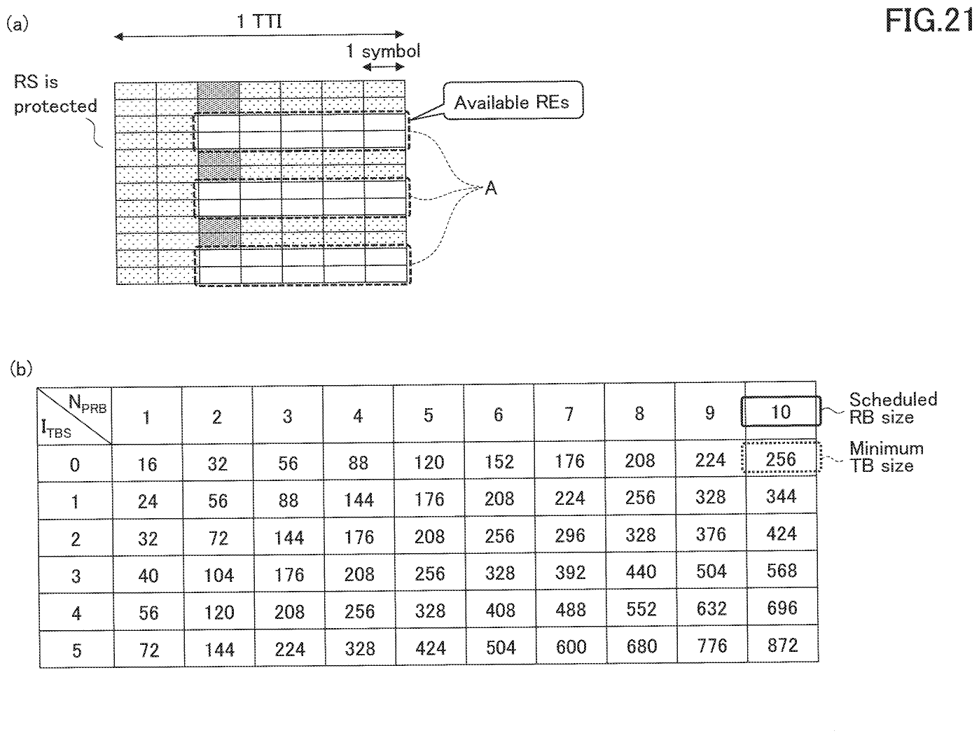

For example, as shown in FIG. 21 (a), when a data area other than the data area indicated by A is protected for normal TTI (when the data area cannot be used for short TTI), subcarriers that can be used for short TTI in the resource block are halved compared to the case without protection.

When the base station 20 transmits DL data to the user equipment 10 using the same method of determining a transport block size as the LTE (non-patent document 2), from the RB size allocated to the user apparatus 10 and the TBS index determined from the MCS, the base station 20 determines the transport block size based on the table shown in FIG. 21 (b), and transmits data of the transport block size. The user equipment 10 specifies the RB index and the TBS index from information included in the DCI received from the base station 20, determines the transport block size based on the table shown in FIG. 21(b) and uses the size for decoding.

Here, in order to improve the reliability of communication, it is desirable to lower the coding rate. In order to lower the coding rate, it is necessary to make the data redundant by rate matching and the like, so it is desirable that the transport block size is small.

However, in the conventional LTE, as shown in FIG. 21 (b), the transport block size is determined by the number of allocated RBs. Thus, by protecting the RE, even if the number of usable REs is limited, the TB size cannot be reduced. It should be noted that FIG. 21 (b) shows that the minimum TB size is 256 when the allocated RB size is 10.

Therefore, in the example 5, scaling (in this case, reducing the size) is performed on the TBS table or the number of RBs allocated by the scheduling. Hereinafter, the scaling for the value of the TBS table will be described as Example 5-1 and the scaling for the number of RBs will be described as Example 5-2.

### Example 5-1: Scaling with Respect to the Value of the TBS Table

In the embodiment 5-1, the user equipment 10/base station 20 scales the value of the TBS table based on the information of the RE to be protected (eg, the amount of RE to be protected). Here, three kinds of values of α=¼, ½ and 1 are specified as the scaling factor α. Which value to use is determined based on the information of RE to be protected (eg the amount of protected RE). In this way, by using a scheme of selecting the scaling factor α from several values, complication of the user equipment 10 can be avoided.

Assuming that k is obtained as the TB size corresponding to N and i from the TBS table when the number of assigned RBs=N and TBS index=i, the user equipment 10/base station 20 calculates α×k as the TB size to be used. The decimal part of α×k may be truncated.

### Example 5-2: Scaling for the Number of RBs

In the example 5-2, the user equipment 10/base station 20 scales the number of RBs based on the information of the RE to be protected (eg, the amount of RE to be protected). Here, three kinds of values of β=¼, ½ and 1 are specified as the scaling factor β. Which value to use is determined based on the information of RE to be protected (eg the amount of protected RE). In this way, by using a scheme of selecting the scaling factor β from several values, complication of the user equipment 10 can be avoided.

For example, when the number of allocated RBs is N, the user equipment 10/base station 20 calculates β×N as the number of RBs to be used. The decimal part of β×N may be truncated.

<Regarding Method of Determining Scaling Factor>

The scaling factor in the user equipment 10 may be notified from the base station 20. Notification of the scaling factor may be performed by DCI for each short TTI (example: per symbol), or may be performed by upper layer signaling.

When determination of the scaling factor in the base station 20 and the notification of the scaling factor from the base station 20 to the user apparatus 10 are not performed, the determination of the scaling factor at the user equipment 10 can be performed, for example, as follows.

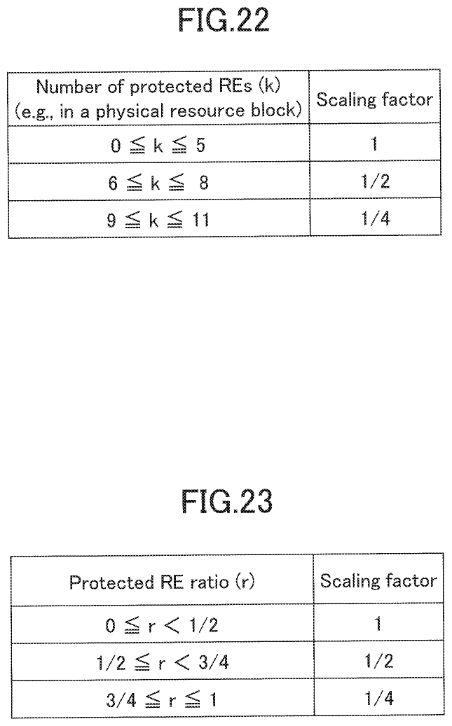

The user equipment 10/base station 20 determines the scaling factor based on the configuration of the RE to be protected. For example, the user equipment 10/base station 20 holds the table shown in FIG. 22 or 23 or the relation between the threshold value and the scaling factor described in the table, and determines a scaling factor based on the table or the relation.

FIG. 22 is an example of a table in the case where a protection pattern (RE to be protected) is configured for each symbol of RB, so that the scaling factor is determined based on the number (k) of REs protected in 1RB.

The scaling may be determined by the correspondence table of the scaling factor using the RE number (k) protected in 1RB as described above, or may be calculated based on the number (k) of REs to be protected or the ratio. For example, assuming that the total number of REs allocated is N, k/N may be used as a scaling factor.

FIG. 23 shows an example of a table in the case where the protection pattern (RE to be protected) is configured for each symbol for each system bandwidth (or channel bandwidth), so that, for example, the scaling factor is determined based on a ratio of the protected RE in the data area in 1TTI with respect to the whole area.

In the example 5, an explanation is given focusing on communication in short TTI as an example, but the application destination of the technique of the example 5 is not limited to this, and it can be similarly applied to normal TTI.

(Apparatus Configuration)

A functional configuration example of the user equipment 10 and the base station 20 that execute the operation of the embodiment described above will be described. Each of the user equipment 10 and the base station 20 has all the functions (including examples 1-5) described in the present embodiment. However, each of the user equipment 10 and the base station 20 may have only some of the functions of all the functions described in this embodiment.

<User Equipment 10>

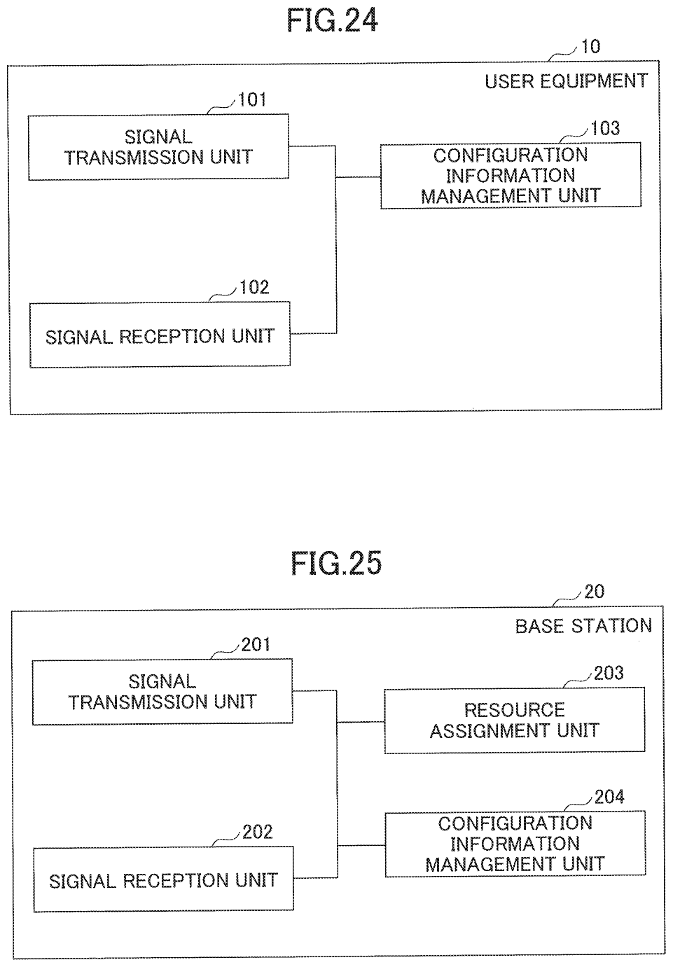

FIG. 24 is a diagram showing an example of a functional configuration of the user equipment 10. As shown in FIG. 24, the user equipment 10 includes a signal transmission unit 101, a signal reception unit 102, and a configuration information management unit 103. The functional configuration shown in FIG. 24 is just an example. As long as the operation according to the present embodiment can be executed, the function division and the name of the functional unit may be anything.

The signal transmission unit 101 is configured to generate a signal of a lower layer from information of the upper layer and transmit the signal by radio. The signal transmission unit 101 may be referred to as a transmitter.

The signal reception unit 102 is configured to receive various signals by radio and acquire information of the upper layer from the received signals. The signal reception unit 102 also includes, for example, a channel estimation function by DMRS, a function of calculating LLR for each bit from a signal detected from radio waves, a function of a turbo decoder for obtaining decoded data using LLR, and the like. The signal reception unit 102 may be referred to as a receiver.

For example, the configuration information management unit 103 stores configuration information (eg, protection pattern information) received from the base station 20 or preconfigured.

The configuration information management unit 103 may be configured to hold configuration information indicating a protection resource that is a resource that is protected from puncturing that may occur in an assigned resource that is a resource assigned by the base station. The signal reception unit 102 may be configured to receive, from the base station, control information indicating that picturing occurs in the assigned resource, and receive, from the base station, a predetermined signal using the protection resource based on the configuration information.

The configuration information includes a plurality of patterns of the protection resource, and the control information includes an identifier of a specific pattern among the plurality of patterns, and the signal reception unit 102 may receive the predetermined signal by a protection resource of the pattern identified by the identifier.

The signal reception unit 102 may receive a signal transmitted in a second TTI using a resource other than the protection resource in the second TTI that corresponds to a time region in which the puncturing is performed in a first TTI in which transmission of the predetermined signal is performed. The signal reception unit 102 may determine a size of a transport block received from the base station in the second TTI based on an amount of the protection resource.

<Base Station 20>

FIG. 25 is a diagram showing an example of a functional configuration of the base station 20. As shown in FIG. 25, the base station 20 includes a signal transmission unit 201, a signal reception unit 202, a resource allocation unit 203, and a configuration information management unit 204.

The functional configuration shown in FIG. 25 is just an example. As long as the operation according to the present embodiment can be executed, the function division and the name of the functional unit may be anything.

The signal transmission unit 201 is configured to generate a signal of a lower layer from the information of the upper layer and transmit the signal by radio. The signal reception unit 202 receives various signals by radio and is configured to acquire information of an upper layer from the received signals. The signal transmission unit 201 may be referred to as a transmitter, and the signal reception unit 202 may be referred to as a receiver.

The resource assignment unit 203 performs resource allocation and the like to the user equipment 10. The resource assignment unit 203 can perform both resource assignment in the normal TTI and resource assignment in the short TTI, and also determines puncture resources in the normal TTI.

The configuration information management unit 204 stores configuration information such as protection patterns. The configuration information may be transmitted to the user equipment 10.

The configuration information management unit 204 may be configured to hold configuration information indicating a protection resource that is a resource protected from puncturing that may occur in an assigned resource that is a resource to be assigned to the user equipment. The signal transmission unit 201 may be configured to transmit, to the user equipment, control information indicating that puncturing occurs in the assigned resource, and transmit, to the user equipment, a predetermined signal using the protection resource based on the configuration information.

<Hardware Configuration>

The above block diagrams (FIGS. 24 and 25) illustrate the blocks of the functional units. The functional blocks (constituent parts) are implemented by an arbitrary combination of hardware and/or software. A device of implementing each functional block is not particularly limited. In other words, each functional block may be implemented by one device which is physically and/or logically combined or may be implemented by a plurality of devices, that is, two or more devices which are physically and/or logically separated and are directly and/or indirectly connected (for example, a wired and/or wireless manner).

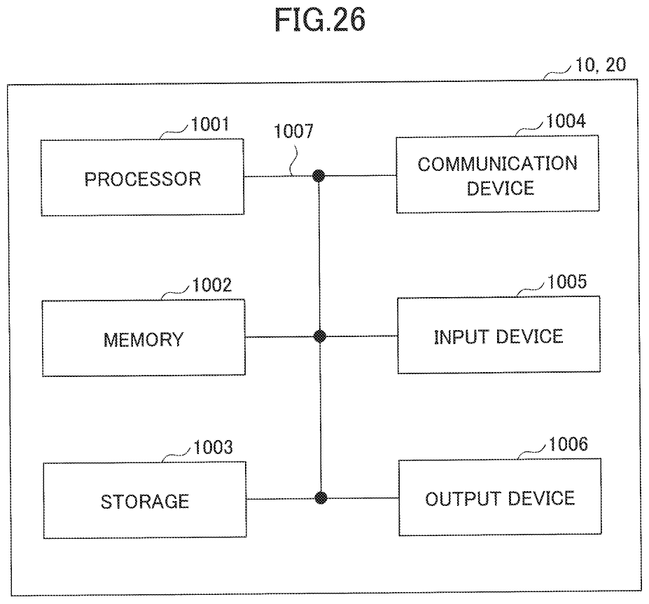

For example, each of the user equipment 10 and the base station 20 according to one embodiment of the embodiment of the present invention may function as a computer that performs the process according to the present embodiment. FIG. 26 is a diagram illustrating an example of a hardware configuration of each of the user equipment 10 and the base station 20 according to one embodiment of the embodiment of the present invention. As illustrated in FIG. 26, each of the user equipment 10 and the base station 20 may physically be configured as a computer device that includes a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of each of the user equipment 10 and the base station 20 may be configured to include one or more devices (units) illustrated in the drawing or may be configured without including some devices.

Each function in each of the user equipment 10 and the base station 20 is implemented such that predetermined software (program) is read on hardware such as the processor 1001 and the memory 1002, and the processor 1001 performs an operation and controls communication by the communication device 1004 and reading and/or writing of data in the memory 1002 and the storage 1003.

For example, the processor 1001 operates an operating system and controls the entire computer. The processor 1001 may be constituted by a central processing unit (CPU: Central Processing Unit) including an interface with a peripheral device, a control device, an operation device, a register and the like.

Further, the processor 1001 reads a program (a program code), a software module, and data from the storage 1003 and/or the communication device 1004 out to the memory 1002, and performs various kinds of processes according to them. As the program, a program causing a computer to execute at least some of the operations described in the above embodiment is used. For example, the signal transmission unit 101, the signal reception unit 102, the configuration information management unit 103 of the user equipment 10 shown in FIG. 24 may be implemented by a control program which is stored in the memory 1002 and operates on the processor 1001. Further, for example, the signal transmission unit 201, the signal reception unit 202, the resource allocation unit 203, the configuration information management unit 204 of the base station 10 shown in FIG. 25 may be implemented by a control program which is stored in the memory 1002 and operates on the processor 1001. Various kinds of processes have been described as being performed by one processor 1001 or may be simultaneously or sequentially performed by two or more processors 1001. The processor 1001 may be implemented by one or more chips. The program may be transmitted from a network via an electric communication circuit.

The memory 1002 is a computer readable recording medium and configured with at least one of a read only memory (ROM), an erasable programmable ROM (EPROM), an electrically erasable programmable ROM (EEPROM), a random access memory (RAM), and the like. The memory 1002 is also referred to as a “register,” a “cache,” a “main memory,” or the like. The memory 1002 can store programs (program codes), software modules, data or the like which are executable for carrying out the processes described in the present embodiment.

The storage 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The storage 1003 is also referred to as an “auxiliary storage device.” The storage medium may be, for example, a database, a server, or any other appropriate medium including the memory 1002 and/or the storage 1003.

The communication device 1004 is hardware (a transceiving device) for performing communication with computers via a wired and/or wireless network and is also referred to as a “network device,” a “network controller,” a “network card,” a “communication module,” or the like. For example, the signal transmission unit 101 and the signal reception unit 102 of the user equipment 10 may be implemented by the communication device 1004. Further, the signal transmission unit 201 and the signal reception unit 202 of the base station 20 may be implemented by the communication device 1004.

The input device 1005 is an input device that receives an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integratedly configured (for example, a touch panel).

The respective devices such as the processor 1001 and the memory 1002 are connected via the bus 1007 to communicate information with each other. The bus 1007 may be configured with a single bus or may be configured with different buses between the devices.

Further, each of the base station 20 and the user equipment 10 may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by at least one of these pieces of hardware.

(Conclusion of the Embodiment)

As described above, according to the present embodiment, there is provided a user equipment in a radio communication system including a base station and the user equipment, including: a configuration information management unit configured to hold configuration information indicating a protection resource that is a resource that is protected from puncturing that may occur in an assigned resource that is a resource assigned by the base station; and a reception unit configured to receive, from the base station, control information indicating that picturing occurs in the assigned resource, and receive, from the base station, a predetermined signal using the protection resource based on the configuration information.

According to this configuration, there is provided a technique for enabling a user equipment to properly receive a predetermined signal transmitted from the base station even when a part of resources for receiving a signal transmitted from the base station is punctured.

The configuration information includes a plurality of patterns of the protection resource, and the control information includes an identifier of a specific pattern among the plurality of patterns, and wherein the reception unit receives the predetermined signal by a protection resource of the pattern identified by the identifier. According to this configuration, since protection pattern is designated by an identifier of a specific pattern, quick processing is possible.

The reception unit receives a signal transmitted in a second TTI using a resource other than the protection resource in the second TTI that corresponds to a time region in which the puncturing is performed in a first TTI in which transmission of the predetermined signal is performed. According to this configuration, even when receiving second TTI, the user equipment can perform proper reception operation.

The reception unit determines a size of a transport block received from the base station in the second TTI based on an amount of the protection resource. According to this configuration, the size of the transport block can be reduced and coding rate can be reduced.

According to the present embodiment, there is provided a base station in a radio communication system including a base station and a user equipment, including: a configuration information management unit configured to hold configuration information indicating a protection resource that is a resource protected from puncturing that may occur in an assigned resource that is a resource to be assigned to the user equipment; and a transmission unit configured to transmit, to the user equipment, control information indicating that puncturing occurs in the assigned resource, and transmit, to the user equipment, a predetermined signal using the protection resource based on the configuration information.

According to this configuration, there is provided a technique for enabling a user equipment to properly receive a predetermined signal transmitted from the base station even when a part of resources for receiving a signal transmitted from the base station is punctured.

(Supplement of Embodiments)

While the embodiment of the present invention has been described, the disclosed invention is not limited to such an embodiment, and various variations, modifications, alterations, and substitutions could be conceived by those skilled in the art. While specific examples of numerical values are used in order to facilitate understanding of the invention, these numerical values are examples only and any other appropriate values may be used unless otherwise stated particularly. The classification of items in the description is not essential in the present invention, and features described in two or more items may be used in combination, and a feature described in a certain item may be applied to a feature described in another item (unless contradiction occurs). It is not always true that the boundaries of the functional units or the processing units in the functional block diagram correspond to boundaries of physical components. The operations of a plurality of functional units may be physically performed by a single component. Alternatively, the operations of the single functional unit may be physically performed by a plurality of components. The orders in the sequence and the flowchart described in the embodiment may be switched unless contradiction occurs. For convenience of explanation of processing, the user equipment 10 and the base station 20 have been explained using functional block diagrams. However, these devices may be implemented by hardware, software, or a combination thereof. The software that operates by a processor included in the UE according to the embodiment of the present invention and the software that operates by a processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, and other appropriate storage media.

Transmission of the information is not limited to the aspects/embodiments described in the invention, but may be performed by other methods. For example, transmission of the information may be performed by physical layer signaling (such as downlink control information (DCI) or uplink control information (UCI)), upper layer signaling (such as radio resource control (RRC) signaling, medium access control (MAC) signaling, broadcast information (such as a master information block (MIB) or a system information block (SIB)), other signaling, or a combination thereof. The RRC message may be referred to as RRC signaling. An RRC message may be, for example, an RRC connection setup message or an RRC connection reconfiguration message.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), or other appropriate systems and/or next-generation systems to which the systems are extended.

The processing procedures, sequences, flowcharts and the like of the aspects/embodiments described above in this specification may be changed in the order as long as they are not incompatible with each other. For example, in the methods described in this specification, various steps as elements are described in an exemplary order and the methods are not limited to the described order.

Specific operations which are performed by the base station in this specification may be performed by an upper node thereof in some cases. In a network including one or more network nodes including a base station, various operations which are performed to communicate with a user equipment UE can be apparently performed by the base station and/or network nodes (for example, an MME or an S-GW can be considered but the network nodes are not limited thereto) other than the base station. A case in which the number of network nodes other than the base station is one has been described above, but a combination of plural different network nodes (for example, an MME and an S-GW) may be used.

The aspects described in this specification may be used alone, may be used in combination, or may be switched with implementation thereof.

The user equipment 10 may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several appropriate terms by those skilled in the art.

The base station 20 may be referred to as an NodeB (NB), an enhanced NodeB (eNB), a base station, or some other appropriate terms by those skilled in the art.

The terms “determining (determining)” and “deciding (determining)” used in this specification may include various types of operations. For example, “determining” and “deciding” may include deeming that to perform judging, calculating, computing, processing, deriving, investigating, looking up (e.g., search in a table, a database, or another data structure), or ascertaining is to perform “determining” or “deciding”. Furthermore, “determining” and “deciding” may include deeming that to perform receiving (e.g., reception of information), transmitting (e.g., transmission of information), input, output, or accessing (e.g., accessing data in memory) is to perform “determining” or “deciding”. Furthermore, “determining” and “deciding” may include deeming that to perform resolving, selecting, choosing, establishing, or comparing is to perform “determining” or “deciding”. Namely, “determining” and “deciding” may include deeming that some operation is to perform “determining” or “deciding”.

An expression “on the basis of ˜” which is used in this specification does not refer to only “on the basis of only ˜,” unless apparently described. In other words, the expression “on the basis of ˜” refers to both “on the basis of only ˜” and “on the basis of at least ˜.”

So long as terms “include” and “including” and modifications thereof are used in this specification or the appended claims, the terms are intended to have a comprehensive meaning similar to a term “comprising.” A term “or” which is used in this specification or the claims is intended not to mean an exclusive or.

In the entire disclosure, for example, when an article such as a, an, or the is added in translation into English, such an article refers to including the plural unless otherwise recognized from the context.

Although details of the present invention have been described, it is clear for the person skilled in the art that the invention is not limited to the above-mentioned embodiments in the description. The present invention can be implemented as modifications and changed forms without departing from the spirit and scope of the present invention as defined by the scope of the claims. Therefore, the description of the present specification is for the purpose of illustration and does not have any restrictive meaning to the present invention.

The present patent application claims priority based on Japanese patent application No. 2016-257020, filed in the JPO on Dec. 28, 2016, and the entire contents of the Japanese patent application No. 2016-257020 are incorporated herein by reference.

### LIST OF REFERENCE SYMBOLS

10 user equipment
101 signal transmission unit
102 signal reception unit
103 configuration information management unit
20 base station
201 signal transmission unit
202 signal reception unit
203 resource assignment unit
204 configuration information management unit
1001 processor
1002 memory
1003 storage
1004 communication device
1005 input device
1006 output device

1. A user equipment in a radio communication system including a base station and the user equipment, comprising:
a configuration information management unit configured to hold configuration information indicating a protection resource that is a resource that is protected from puncturing that may occur in an assigned resource that is a resource assigned by the base station; and
a reception unit configured to receive, from the base station, control information indicating that puncturing occurs in the assigned resource, and receive, from the base station, a predetermined signal using the protection resource based on the configuration information.

2. The user equipment as claimed in claim 1, wherein the configuration information includes a plurality of patterns of the protection resource, and the control information includes an identifier of a specific pattern among the plurality of patterns, and wherein
the reception unit receives the predetermined signal by a protection resource of the pattern identified by the identifier.

3. The user equipment as claimed in claim 1, wherein the reception unit receives a signal transmitted in a second TTI using a resource other than the protection resource in the second TTI that corresponds to a time region in which the puncturing is performed in a first TTI in which transmission of the predetermined signal is performed.

4. The user equipment as claimed in claim 3, wherein the reception unit determines a size of a transport block received from the base station in the second TTI based on an amount of the protection resource.

5. A base station in a radio communication system including a base station and a user equipment, comprising:
a configuration information management unit configured to hold configuration information indicating a protection resource that is a resource protected from puncturing that may occur in an assigned resource that is a resource to be assigned to the user equipment; and
a transmission unit configured to transmit, to the user equipment, control information indicating that puncturing occurs in the assigned resource, and transmit, to the user equipment, a predetermined signal using the protection resource based on the configuration information.

6. A signal reception method executed by a user equipment in a radio communication system including a base station and the user equipment, comprising:
a step of holding configuration information, in a configuration information management unit, indicating a protection resource that is a resource that is protected from puncturing that may occur in an assigned resource that is a resource assigned by the base station; and
a step of receiving, from the base station, control information indicating that puncturing occurs in the assigned resource, and receiving, from the base station, a predetermined signal using the protection resource based on the configuration information.

7. The user equipment as claimed in claim 2, wherein the reception unit receives a signal transmitted in a second TTI using a resource other than the protection resource in the second TTI that corresponds to a time region in which the puncturing is performed in a first TTI in which transmission of the predetermined signal is performed.
